(19) United States
(12) Patent Application Publication
(10) Pub. No.: US 2016/0140568 A1
(43) Pub. Date: May 19, 2016

(54) Credential Verification And Analysis System For Professional And Networking Platforms

(71) Applicant: Najih Naser, Cary, NC (US)

(72) Inventor: Najih Naser, Cary, NC (US)

(21) Appl. No.: 14/541,138

(22) Filed: Nov. 13, 2014

(51) Int. Cl. G06Q 30/00; G06Q 10/10

(52) U.S. Cl. CPC G06Q 30/018; G06Q 10/1053

(57) ABSTRACT

A data submission and evaluation system is disclosed. The information items are assigned preference value of a plurality associated with one or more items. Data items are verified individually and in combination to generate ranking indices and professional profiles to visualize and share.

REFERENCES CITED
U.S. PATENT DOCUMENTS

| | | |
|---|---|---|
| 6,341,169 B1 | January 2002 | Normand et al. |
| 6,571,214 B2 | March 2003 | Newman et al. |
| 7,136,513 B2 | November 2006 | Waemer et al. |
| 7,827,410 B2 | November 2010 | Korosec |
| 2013/0067348 A1 | March 2013 | Kast |
| 2013/0066884 A1 | March 2013 | Kast et al. |
| 8,290,836 B2 | October 2012 | McNelley et al. |
| 8,321,295 B1 | November 2012 | Myslinski |
| 8,406,480 B2 | March 2013 | Grigsby et al. |
| 2014/0007224 A1 | February 2014 | Lu et al. |

### CROSS REFERENCES OF RELATED APPLICATION

This application claims the benefit of U.S. Provisional Patent Application Ser. No. 61/903,961, filed on Nov. 14, 2013.

FIELD OF THE DISCLOSURE

This disclosure relates to information collection and data analysis

BACKGROUND

The present invention relates to the field of information and data gathered to verify and establish professional qualifications and credentials.

With the rise in technology advancement, identity theft and other forms of misrepresentation there is a need for a trusted network space with credential verification and quantitative credential analysis system. This can be for the purpose of establishing identity, collaboration, suitability for a position or eligibility to complete a transaction.

Professional evaluators are faced with a vast amount of information and claimed achievements which can be difficult to locate and verify. The problem is exacerbated by the number of applicants, the vast number of credential awarding institutions, the large number and diverse level of businesses and the many social media outlets to which applicants may belong. Unfortunate events happen after people are employed and trained to fulfil important positions to later discover untrue claimed achievements were made by candidates. It has happened in many organizations including very high executive positions. The events ranged from misrepresentation about attending or obtaining a certain college degree, holding a position at a company, authoring articles or patents applications that were never issued, to holding a license or certification to practice a trade. Prior art focused on identity information for security purposes based on authentication of signatures, use of terminals, facial recognition and fact checking against positive and negative databases. Other verifications including negative database scan are fragmented and used to authenticate personal and professional transactions by conducting interviews, calling references, background checks, document inspections and the like which are costly, time consuming and labor intensive processes.

There has not been a comprehensive credential platform that verifies stationary and non-stationary credentials with proper and absolute values where the data is voluntarily given by the principal and data credibility is verified and quantified based on its source. Thus, it would be desirable for candidates and prospective employers to submit and verify collected data in one space to assist candidates in presenting their credentials and experience in a fair and equitable way. The present invention provides such flexible and comprehensive verification and evaluation system in a fair and timely manner.

### SUMMARY

The present invention illustrates a platform to collect, verify and evaluate itemized professional qualifications and credentials in a comprehensive system and method as proof ready profiles to view or share and use on network platforms. Furthermore a uniform evaluation and ranking analysis system is needed to score validated credentials in relation to members of its group and linked to the time of the achievement. Additional qualification items and character parameters may be processed for correctness and absolute worth at the time of the achievement as well, so not to penalize or unduly credit a candidate for future or unforeseen events.

Since the data is life achievements for an individual or entity it is an object of the current invention to provide a finished itemized credentials and reporting system of validated and ranked data, thereby eliminating the need to revalidate and analyze by potential clients, saving time and cost. This system disclosed ties people, their education, job experience and other characteristics including digital social behavior in one comprehensive space. It also allows a client (such as an employer considering several candidates) the option to select multiple candidates and compare them at each level or category in their resume. The system may generate a smart report of similarities and differences with a sore card based for all categories.

### BRIEF DESCRIPTION OF THE DRAWINGS

FIG. 1 is a schematic chart of data and information categories.

FIG. 2 is a schematic chart of information categories and itemized verification flow.

FIG. 3 illustrates itemized ranking factor (RF) for the generation of credential scores.

FIG. 4 illustrates itemized data verification and ranking including professional, social and cumulative intelligence indices.

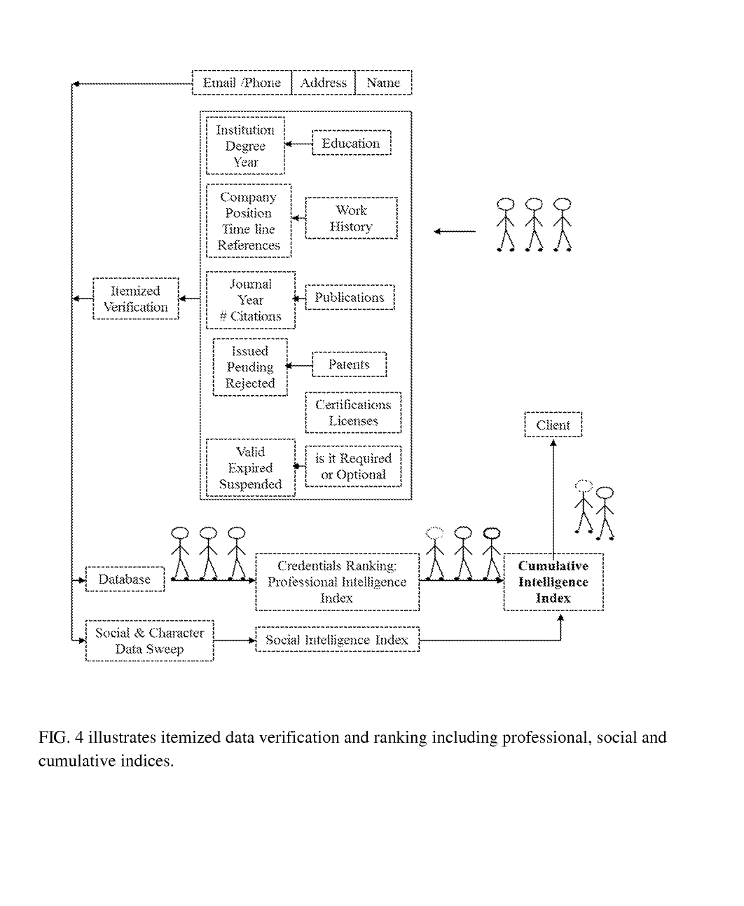

### DETAILED DESCRIPTION

This disclosure is generally described to illustrate a platform to collect, verify and evaluate components within a populated data set such as a resume or a profile. Data items are verified for correctness and significance. Itemized information is assigned a value of significance (ranking factor) to score candidates based on their credentials and experience. For example, institutes of higher education are considered for their rank amongst their peers, journals are ranked based on their impact, articles and patents are valued based on their impact and citation number by others in the field. Businesses also vary from a fortune 500, global, national, franchised organization and small business. The collective data from education, work experience, certifications, background, financial standing and social media behavior and reputation provide great benefits in a selection process for employment, collaboration, association, networking, lending and many other considerations. It should be recognized that the various embodiments, charts and examples are merely illustrations of the various objectives and principles of the present invention.

According to one aspect of the invention a platform with uniform categories and specific protocols are featured to populate data sets. Each category comprises subsets of data and descriptions. The candidate user can be a person, entity or equity with corresponding data categories provided through an online interview or data uploads. The awarding source is contacted to validate the claimed credit, position, duration and the like.

In another embodiment candidates, organizations, properties and businesses are valued based on their significance among peers and industry. For example, the candidate's achievements are ranked based on the awarding institute, the program attended and the degree awarded.

Another embodiment and defining object of the present invention is to provide an analytical ranking system and method for establishing a quantitative value for each achievement. The verified data and professional experience are characterized with an algorithmic hierarchy assessment system. It ties candidates with their education, job history, experience, type and number of achievements including certifications and publications in one credential evaluation to be known as the professional intelligence index. The object of the present invention is to provide a real-time system for ranking achievements and credentials to enable a true and reliable measure in a report or a profile shared through professional meeting space.

Another embodiment would include data collected from multiple sources including social media feeds to develop a behavioral pattern and character profile. This data is used as indicator of a candidate's reputation, character, reliability, strength, weakness and risk management to generate a social intelligence index. Although the embodiments and examples disclosed herein illustrate a dynamic professional system for verifying and ranking achievements to provide a true and reliable measure of a profile in a report or shared through professional meeting space, it is not limited and may be used to create a true and quantitative measure of value for an entity or equity.

### EXAMPLE 1

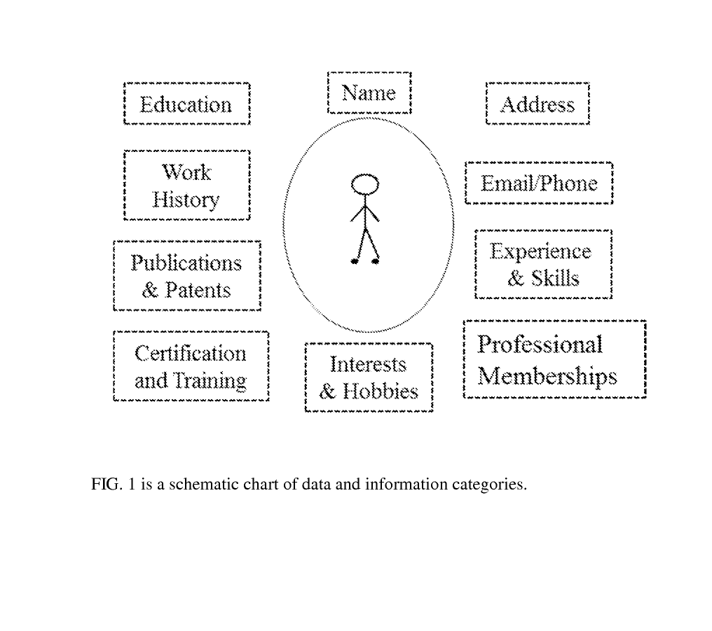

As illustrated in FIG. 1, a candidate user starts by creating an account or profile comprises of personal information and lifetime achievements and credits typically found in a resume or curriculum vitae.

### EXAMPLE 2

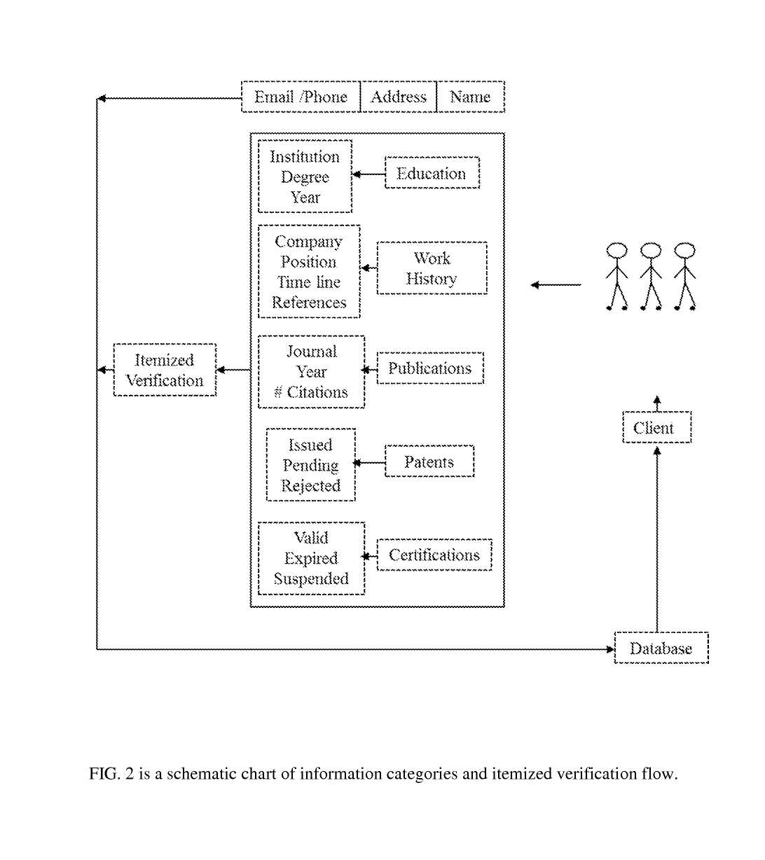

FIG. 2 shows an extended view of itemized data categories with ordinary information fields such as name, address, Email, telephone number, university or college attended, degree, year of graduation, etc.). Work experience listing, position held and duration in addition to employer contact information are also filled for each position. The system will alert candidates when overlaps occur and prompt for correction. The candidate user may also provide contact information for past and current supervisors, professors and references who may provide professional assessment and appraisal on his behalf to the system's confidential sub database. Such important feature is of great benefit to the candidate and third parties because it is collected, verified and stored in confidence and while a candidate's performance is fresh and clear in the appraiser's mind, hereby eliminating the need for multiple communications with references or worse the loss of supportive letters for job openings the candidate may apply for. Accomplished candidates and authors may also benefit from the listing of abstracts, thesis, dissertation or patents which can be linked to their profile so recruiters, potential employers and collaborators can benefit from its relevance to their business.

### EXAMPLE 3

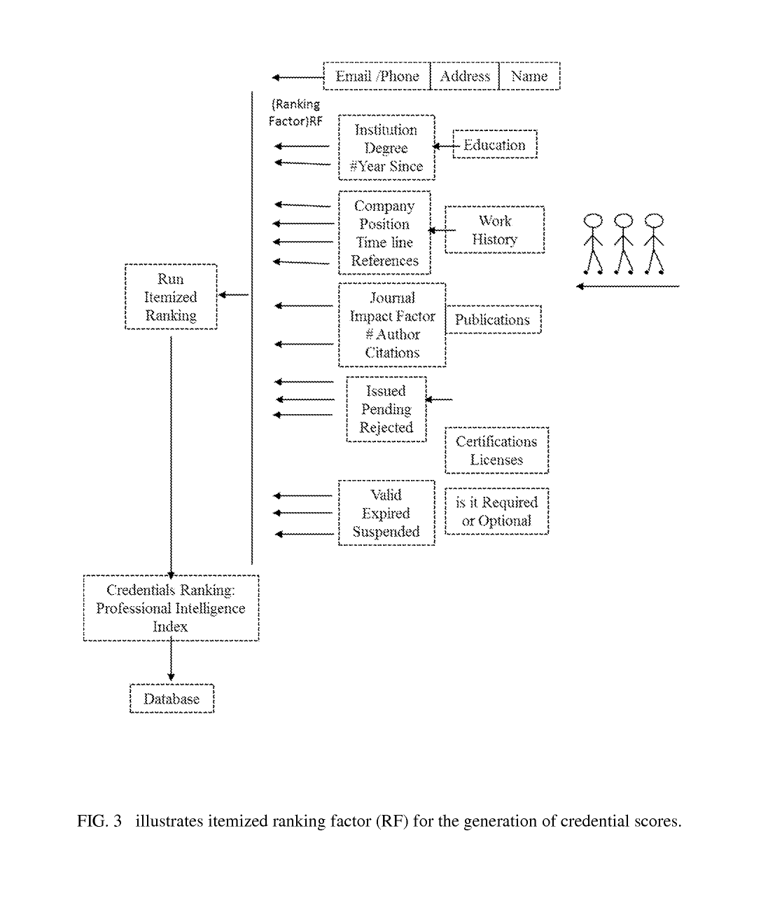

A defining object of the present invention is to provide an analytical ranking system and method for establishing quantitative values for each achievement and credential as illustrated in FIG. 3. The verified achievements are treated as facts for scoring and algorithmic analysis in the hierarchy assessment system comprised of a ranking factor multiplied by achievement level multiplied by time period. The ranking Factor (RF) is a numerical value assigned to credentials and sources such as institutions, businesses, degrees, journals, certificates, and the like based on their own ranking amongst peers or groups. For example, a university is ranked according to its standing within listings of universities and institutions of higher education, a degree differs in being BA/BSc., MSc., Ph. D., MD, or a license to practice a profession carries a ranking factor to establish true credit to a candidate. Similarly for published work, a published author or inventor will be granted ranking points based on the journal's impact, number of publications, number of citations of the work published, number and type of patents, etc. As positives are credited, also negatives are also accounted for, such as in the unfortunate event of a violation where a candidate ranking may be lowered by the level of citation as in the case of a licensed contractor cited for bad work or unfulfilled project.

### EXAMPLE 4

The credential ranking analysis is shown in the following categories. For example, the professional intelligence index is calculated as the sum of these categories.

Education=RF ᵢₙₛₜᵢₜᵤₜᵢₒₙ₁ (degree₁)+RF ᵢₙₛₜᵢₜᵤₜᵢₒₙ₂ (degree₂)+RF ᵢₙₛₜᵢₜᵤₜᵢₒₙ₃ (degree3)

Work experience=RF _{company1} (position₁) (number of years)+RF _{company2} (position₂) (number of years)+RF _{company3} (position3) (number of years)

Publications=RFⱼₒᵤᵣₙₐₗ₁ (number of articles)+RFⱼₒᵤᵣₙₐₗ₂ (number of articles)+RFₚₐₜₑₙₜ (patent type) (number of patents)

Trade=RF_{licence1} (valid)-RF_{licence2} (suspended)

What is claimed is:

1. A data submission and verification system to collect, verify and analyze information items, achievements and credentials to visualize and share.

2. The information data system of claim 1 relates to personal information, education, professional positions and experience, academic and professional achievements, certifications and publications, social media behavior characterization, lifetime events and reference appraisals.

3. The information items of claim 2 is linked and assigned a preference value and ranking factor of a plurality for the item and its origin.

4. The preference and ranking factor items of claim 3 is associated with an organization, a merit, an achievement, a position, a publication, an invention, a software program, and time experience.

5. The system of claims 1, 2 and 3 wherein the data is used to create quantitative indices including academic intelligence index, a professional intelligence index, a social intelligence index, and a cumulative intelligence index.

6. The indices of claim 5 wherein a cumulative intelligence index may be generated and used to characterize and rank a candidate or a group of candidates to each other or on national level.

7. The profiles and categories of claims 1, 2, 3, 4, 5 and 6 relate to persons or entities.

8. The system of claims 1, 2, 3, 4, 5, 6 and 7 providing verified and quantitative profile in print or for use by networking platforms and meeting space to visualize, share, link and collaborate.
